(19) United States
(12) Patent Application Publication
(10) Pub. No.: US 2008/0002211 A1
(43) Pub. Date: Jan. 3, 2008

(54) SYSTEM, ARRANGEMENT AND PROCESS FOR PROVIDING SPECKLE REDUCTIONS USING A WAVE FRONT MODULATION FOR OPTICAL COHERENCE TOMOGRAPHY

(75) Inventors: Boris Hyle Park, Somerville, MA (US); Johannes F. De Boer, Somerville, MA (US)

Correspondence Address: DORSEY & WHITNEY LLP;INTELLECTUAL PROPERTY DEPARTMENT, 250 PARK AVENUE, NEW YORK, NY, 10177, US

(73) Assignee: The General Hospital Corporation, Boston, MA (US)

(21) Appl. No.: 11/624,334

(22) Filed: Jan. 18, 2007

Related U.S. Application Data
(60) Provisional application No. 60/760,592, filed on Jan. 20, 2006.

(51) Int. Cl. G01B 9/02

(52) U.S. Cl. 356/512

(57) ABSTRACT

Exemplary systems and methods for generating information associated with at least one portion of a sample can be provided. For example, it is possible to receive from the at least one portion and/or transmit to at least one electromagnetic radiation to the portion. At least one first wave front of the electro-magnetic radiation received from and/or transmitted to the portion can be provided to generate at least one first transmitted wave front. After the first transmitted wave front is generated, at least one characteristic of at least one second wave front of the electromagnetic radiation received from and/or transmitted to the portion can be modified to generate at least one second modified wave front which is different from the first transmitted wave front. Further, the information can be generated based on the first transmitted wave front and the second modified wave front.

### CROSS-REFERENCE TO RELATED APPLICATION(S)

This application is based upon and claims the benefit of priority from U.S. Patent Application Ser. No. 60/760,592, filed on Jan. 20, 2006, the entire disclosure of which is incorporated herein by reference.

### STATEMENT REGARDING FEDERALLY SPONSORED RESEARCH

The invention was made with the U.S. Government support under Contract Nos. RO1EY014975, RO1RR019768 awarded by the National Institute of Health, and Contract No. F49620-021-1-0014 awarded by the Department of Defense. Thus, the U.S. Government has certain rights in the invention.

### FIELD OF THE INVENTION

The present invention relates to systems, arrangements and methods for optical imaging using a light beam reflected from a sample surface and compared to a reference light beam, wherein the wave front of light returning from the sample is modified in successive measurements such that acquired data can be used to reduce the appearance of speckle. The exemplary systems, arrangements and methods can allow for reduced speckle contrast within a single Optical Coherence tomography image with little to no reduction in lateral and axial resolution.

### BACKGROUND INFORMATION

Optical coherence tomography is an imaging technique that measures the interference between a reference beam of light and a detected beam reflected back from a sample. A detailed system description of traditional time-domain OCT was first described by Huang et al. (see publication labeled by numeral [1] as indicated herein below). Exemplary detailed descriptions for spectral-domain OCT and optical frequency domain interferometry systems and processes are described in, for example, International Patent Application PCT/US2004/029148, filed Sep. 8, 2004, U.S. patent application Ser. No. 11/266,779, filed Nov. 2, 2005, and U.S. patent application Ser. No. 10/501,276, filed Jul. 9, 2004, the disclosures of which are incorporated by reference herein in their entireties. In all these exemplary systems and processes, a series of depth scans can be compiled to create a cross-sectional image of the sample.

Various extensions can provide additional information on tissue properties over the OCT imaging processes and systems alone. For example, polarization sensitive OCT (PS-OCT) can provide additional systems and processes which utilize the sensitivity to light polarization changing properties of the sample (see publications labeled by numerals [2-6] as indicated herein below). A simultaneous detection of interference fringes in two orthogonal polarization channels may allow for a determination of the Stokes parameters of light (see publication labeled by numeral [6] as indicated herein below). A comparison of the Stokes parameters of the incident state to the state obtained by the reflected signals from the sample can yield a depth-resolved map of optical properties such as birefringence (see publication labeled as [6]). In addition, optical Doppler tomography (ODT) systems and processes are capable of depth-resolved imaging of flow (see publications labeled by numerals [7-10] as indicated herein below). The flow sensitivity can be achieved by measuring the shift in carrier frequency of the interference fringe pattern due to backscattering of light from moving particles, or by comparing the phase of the interference fringe pattern from one A-line to the next. Phase-resolved optical Doppler tomography (ODT) systems and processes (see publications labeled by numerals [9, 10] as indicated herein below) can enable depth-resolved imaging of the flow by observing differences in a phase between successive depth scans.

One of the main sources of speckle in OCT is discussed in Schmitt et al. (see publication labeled by numeral [11] as indicated herein below). In this publication, it was provided that the changes that a focused wave incident on the tissue undergoes as it propagates through the tissue to the sample volume, scatters back, and then propagates once again through the tissue back to the lens should be considered. This publication also provides that two main processes influence the spatial coherence of the returning wave: (1) multiple backscattering of the beam inside and outside of the desired sample volume and (2) random delays of the forward-propagating and returning beam caused by multiple forward scattering. Although the first of these is the primary source of speckle in rough-surface imaging, the second must also be considered in coherent imaging systems like OCT, that utilize penetrating waves. The common feature of both processes (as indicated in this publication) is that they alter the shape of the wave front of the returning beam and create localized regions of constructive and destructive interference that appear as speckle in OCT images (referring to publication labeled [12] as indicated herein below).

For example, the wave front of light returning from a particular location in a sample is modified by other parts of the sample. These other portions of the sample, including nearby regions that contribute to multiple backscatter and regions along the optical path of light returning from the particular location, can be thought of as a filter that alters the shape of the wave front of the returning beam. The effect of the filter creates the localized constructive and destructive interference pattern that forms the resulting speckle pattern. Alterations on the order of a fraction of the wavelength of light used for imaging in the sample will result in a different filter, and consequently, also a different speckle pattern.

The standard deviation of a polarized speckle pattern is equal to its mean intensity. (See publication labeled by numeral [13] as indicated herein below). Consequently, speckle can mask the presence of small, thin, or weakly reflecting structures in intensity images. In addition, the accuracy with which phase can be determined improves with higher signal-to-noise ratio (“SNR”). Regions for which the intensity of reflected light has been suppressed by speckle will therefore have a lower SNR and therefore higher uncertainty in phase determination. Since both polarization-sensitive and Doppler OCT measurements rely on phase determination, the accuracy of polarization property and flow determination will suffer in these localized regions of speckle-derived destructive interference. Therefore, the ability to reduce speckle contrast can be of benefit to traditional intensity based OCT as well as to extensions such as PS-OCT and Doppler OCT.

The size of the smallest structures resolvable by OCT imaging is determined by the lateral and axial resolution of the OCT system. The axial resolution is primarily determined by the spectral bandwidth of the source, while the lateral resolution is governed by the optics with which light is focused into the sample. Modulation of the focus on the sample can yield information on the presence of structures smaller than the lateral resolution.

There are several existing solutions to the problem of speckle reduction in OCT. The simplest method is to simply average a number of normally acquired OCT images of the same sample. Besides requiring multitude of images, the main problem with this method is that while each image has its own speckle pattern, these patterns are often very highly correlated. This is the case for rapidly acquired images in succession, and consequently, the reduction in speckle contrast can be difficult to appreciate.

In particular, polarization diversity can also be used to reduce speckle in OCT images by using an unpolarized source beam and measuring the interference between the reference and sample arms of the interferometer in a polarization-sensitive manner. The reasoning behind this technique is that images generated by the two orthogonal polarization states will have their own speckle patterns. However, the two main disadvantages of this method are that the reduction in the SNR of a speckle pattern is limited, and such a technique cannot be used in a PS-OCT system.

In spatial compounding, the absolute magnitudes of signals derived from the sample volume or slightly displaced sample volumes are averaged to form a new signal with reduced speckle noise. The effectiveness of the technique is determined by the number of signals that are averaged together. A number of previous applications of this technique in OCT have been used in the form of angular compounding, where an array of detectors located in the back Fourier plane of the objective lens receives light backscattered from the same sample volume at different angles (see publication labeled by numeral [11] as indicated herein below). These methods are complicated in terms of system implementation and increase the amount of data that should be acquired.

Frequency compounding uses the reduced correlation between speckled images for different optical wavelength ranges. The correlation between resulting speckle patterns for small sub-bands of the full spectrum of the optical source depends on the size and overlap of the sub-bands (see publication labeled by numeral [11] as indicated herein below). However, any reduction in optical bandwidth will likely result in a loss in an axial resolution, making this method possibly unsuitable for use with OCT.

Further, a number of post-processing methods have been used to reduce speckle in OCT images. These techniques include median filtering, homomorphic Weiner filtering, multi-resolution wavelet analysis, and adaptive smoothing (see publication labeled by numeral [11] as indicated herein below). While several of these techniques are effective, they require extensive computation.

Accordingly, it may be beneficial to address and/or overcome at least some of the deficiencies described herein above.

### SUMMARY AND EXEMPLARY OBJECTS OF THE PRESENT INVENTION

One of the objectives of the present invention is to overcome certain deficiencies and shortcomings of the conventional systems and methods (including those described herein above), and provide exemplary embodiments of systems, arrangements and methods for optical imaging using a light beam reflected from a sample surface and compared to a reference light beam, wherein the wave front of light returning from the sample is modified in successive measurements such that acquired data can be used to reduce the appearance of speckle.

There are several exemplary aspects of exemplary embodiments of the present invention that which is beneficial for reducing the speckle contrast. For example:
a. Speckle reduction can be achieved within a single image by averaging small numbers of depth scans with different speckle patterns. Implementation of this technique does not always increase the amount of data that needs to be acquired.
b. Implementation into a pre-existing OCT system by the addition of a wave front altering element in the sample arm beam path.
c. Reduction of speckle contrast in an image can be achieved without complicated post-processing.
d. Application to a more complex imaging system, such as an OCT system designed for adaptive optics, or with optics designed for high-resolution.
e. Application to other variants of OCT, such as polarization-sensitive OCT and Doppler OCT.
f. Detection of structures smaller than the focal volume of light on the sample.

Any optical imaging system in which coherence light interferes would likely have speckle, and can benefit from the exemplary embodiments of the present invention. For example, a device can be added into the sample beam path of a pre-existing imaging system, such as an OCT system or a confocal microscope, to rapidly modify the wave front reflected from the sample back into the imaging system. Averaging a small number of measurements obtained using this exemplary device from the same or nearby locations may reduce the appearance of speckle in resulting images. In addition, proper use and analysis of data obtained while using this device will allow for detection of structures smaller than the focal volume.

According to an exemplary embodiment of the present invention, systems and methods for generating information associated with at least one portion of a sample can be provided. For example, it is possible to receive from the at least one portion and/or transmit to at least one electromagnetic radiation to the portion. At least one first wave front of the electromagnetic radiation received from and/or transmitted to the portion can be provided to generate at least one first transmitted wave front. After the first transmitted wave front is generated, at least one characteristic of at least one second wave front of the electromagnetic radiation received from and/or transmitted to the portion can be modified to generate at least one second modified wave front which is different from the first transmitted wave front. The above can be performed by at least one first arrangement. Further, the information can be generated based on the first transmitted wave front and the second modified wave front, e.g., using at least one second arrangement.

In another exemplary embodiment of the present invention, at least one characteristic of the first wave front can be modified to generate a first modified wave front prior to the modification of the characteristic of the one second wave front. The information can be generated based on the first and second modified wave fronts. Further information can be generated based on the first and second modified wave fronts, and the further information may be associated with a particular volume of the portion which is smaller than a focal volume of the portion that receives the electromagnetic radiation. The first arrangement can include a micro-deformable mirror, a deformable reflective membrane, a deformable transmissive membrane, an electro-optical spatial light modulation arrangement, a rotating or translating, reflective or transmissive element, and/or an apparatus which is configure to modify a wave front of the at least one electro-magnetic radiation.

According to yet another exemplary embodiment of the present invention, the information can be averaged to produce resultant data in which a speckle noise is lower than the speckle noise in the information. The first arrangement may be situated in a catheter arrangement. The second arrangement can include an interferometric arrangement which may receive at least the first and second wave fronts from a sample arm and a further electromagnetic radiation from a reference arm. The first and second wave fronts may be associated with approximately the same focal volume within the portion of the sample. The second arrangement can include a confocal microscope arrangement. The characteristic of the second wave front of the electromagnetic radiation can be a phase of the second wave front, and wherein the phase can be modified by at most approximately 2π.

In a further exemplary embodiment of the present invention, it is possible to compensate for a predetermined wave front distortion associated with the portion of the sample and/or an optical beam path within the first arrangement and/or the second arrangement. The first arrangement can further include at least one third arrangement which may be at least one optical fiber and/or a structure having a pinhole. The third arrangement can select at least one portion of the electromagnetic radiation received from the portion of the sample. The information may be associated with a reflectivity of, a motion within and/or a polarization property of the at least one portion. A further arrangement can be provided which is configured to scan the portion using the electro-magnetic radiation over the portion to generate further information which is associated with a two-dimensional image and/or a three-dimensional image of the portion (e.g., an anatomical structure).

Other features and advantages of the present invention will become apparent upon reading the following detailed description of embodiments of the invention, when taken in conjunction with the appended claims.

### BRIEF DESCRIPTION OF THE DRAWINGS

Exemplary objects, features and advantages of the invention will become apparent from the following detailed description taken in conjunction with the accompanying figures showing illustrative embodiments of the invention, in which:

FIG. 1 is an illustration of an exemplary embodiment of a reflective method of a wave front modification to effect speckle reduction according to the present invention;

FIG. 2 is an illustration of an exemplary embodiment of a transmission method of the wave front modification to effect the speckle reduction according to the present invention;

FIG. 3 is a flow diagram of an exemplary embodiment of a process in accordance with the present invention;

FIG. 4 is an illustration of an exemplary implementation of a use of the system and process in accordance with an exemplary embodiment of the present invention, which uses a collimator that directs a beam to a micro-deformable mirror;

FIG. 5 is an illustration of an exemplary implementation of a use of the system and process in accordance with an exemplary embodiment of the present invention, which uses additional lenses in a telecentric configuration;

FIG. 6 is a scatter plot of exemplary lateral and axial resolutions resulting from various micro-deformable mirror patterns generated in accordance with exemplary embodiments of the present invention;

FIG. 7 is a graph of exemplary signal to noise ratio for increasing amplitude micro-deformable mirror patterns generated in accordance with exemplary embodiments of the present invention;

FIG. 8 are intensity and phase retardation images for an exemplary sample of a chicken muscle imaged with a single stationary pattern (left pair) and alternating between two different mirror patterns (right pair);

FIG. 9 are graphs of axial FWHM, intensity speckle contrast ratio, and standard deviation of phase retardation plots for the exemplary sample of the chicken of FIG. 8 in accordance with the exemplary embodiments of the present invention; and

FIG. 10 are images for a region of an exemplary human fingertip acquired in vivo using a stationary mirror pattern (left set) and alternating between two different mirror patterns (right set) in accordance with the exemplary embodiments of the present invention.

Throughout the figures, the same reference numerals and characters, unless otherwise stated, are used to denote like features, elements, components or portions of the illustrated embodiments. Moreover, while the subject invention will now be described in detail with reference to the figures, it is done so in connection with the illustrative embodiments. It is intended that changes and modifications can be made to the described embodiments without departing from the true scope and spirit of the subject invention as defined by the appended claims.

### DETAILED DESCRIPTION OF EXEMPLARY EMBODIMENTS

Exemplary embodiments of the present invention include certain modifications to the sample arm of an exemplary OCT imaging system, and may also include a device to modify the detected spatial mode of light returning from a sample (e.g., modifying the wave front of light returning from the sample). For example, a small number of measurements acquired from the same or nearby locations with different settings of the device can be averaged together in such a way to reduce speckle contrast in a single image with little loss in axial or lateral resolution. This may provide for better imaging of small, thin, or weakly reflecting structures that might otherwise be masked or difficult to resolve due to the presence of speckle. Data obtained while using the device can also be used to detect the presence of structures smaller than the focal volume.

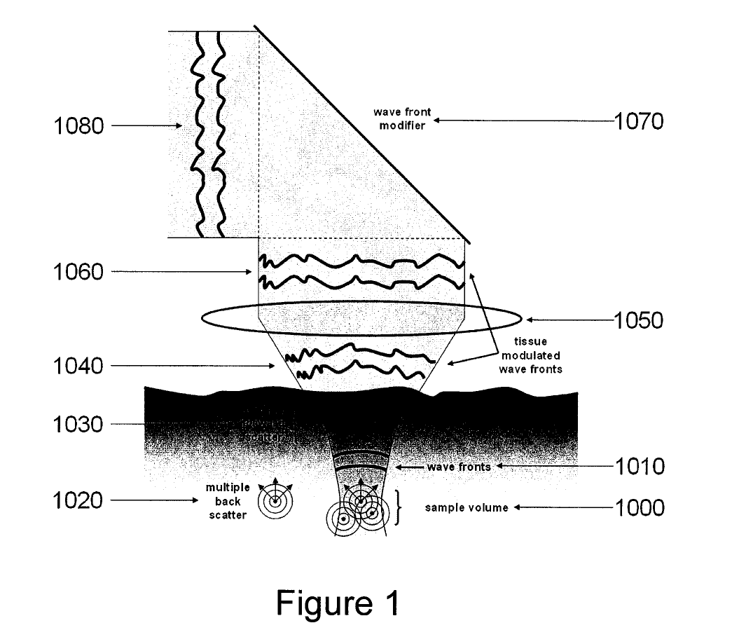

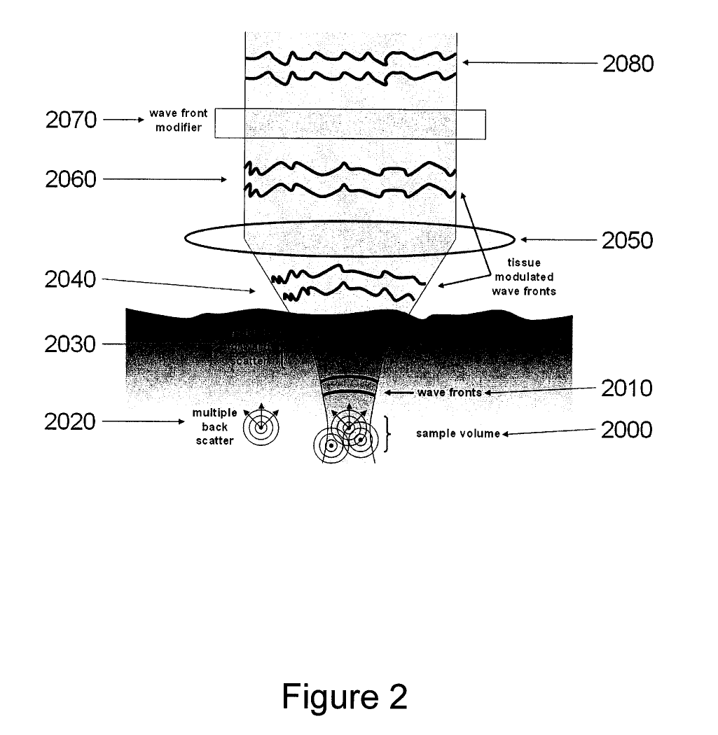

FIG. 1 provides an illustration of an exemplary embodiment of a reflective method of a wave front modification to effect speckle reduction according to the present invention. FIG. 2 provides an illustration of an exemplary embodiment of a transmission method of the wave front modification to effect the speckle reduction according to the present invention. For example, the wave front of light returning (1010 of FIG. 1 and 2010 of FIG. 2) from the focal volume (1000 of FIG. 1 and 2000 of FIG. 2) of a sample can be modulated by other parts of the sample (1020, 1030 of FIG. 1, and 2020, 2030 of FIG. 2), likely giving rise to a specific speckle issue. An element (1070 of FIG. 1 and 2070 of FIG. 2) can be introduced in the sample optical beam path to further modify the wave front, resulting in a different speckle pattern. The wave front modifications can be varied for successive depth or lateral scans, such that these scans will have different speckle patterns. Averaging small numbers of scans will then result in an image with reduced speckle contrast with no change in the structure of derived images.

Two exemplary ways of introducing such wave front which is capable of modifying optical element in the sample arm beam path may be via reflection and transmission, as shown in FIGS. 1 and 2, respectively. In these exemplary methods, the overall path lengths of small beamlets within the full sample light beam are modified by a wave front modification component (1070 of FIG. 1 and 2070 of FIG. 2) slightly with respect to one another, resulting in an altered wave front for the overall beam (1080 and 2080). By changing this beamlet-modification pattern from depth scan to depth scan, different speckle patterns can be created. The amplitude of these relative movements need only be on the order of fractions of the optical wavelength to significantly alter the speckle pattern. The pattern of relative path length alterations can be modified from one depth scan to the next, and the resulting measurements for a small number of depth scans from the same or nearby regions can be averaged to achieve speckle reduction within a single image. While at least two such depth scans with different speckle patterns are preferable, any number of wave front patterns and depth scans can be used to further improve the reduction of speckle.

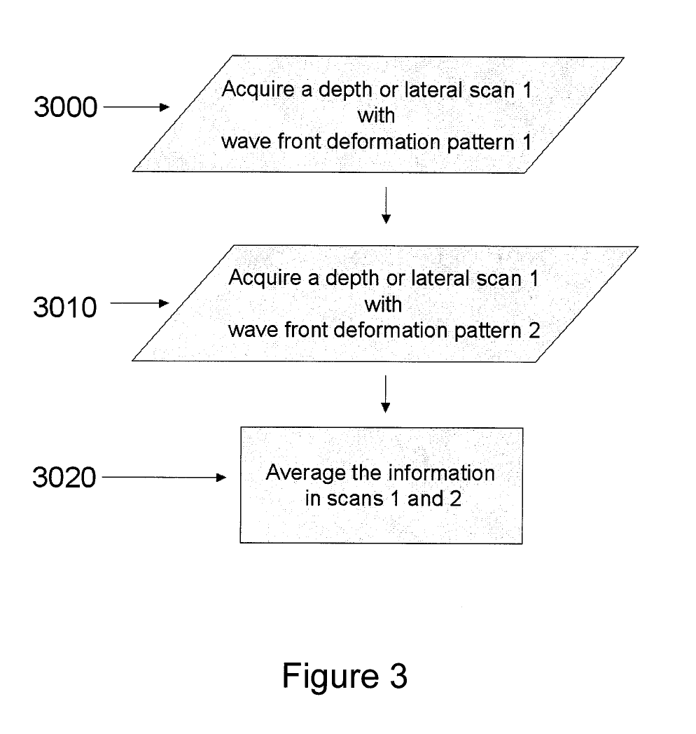

A flow diagram of an exemplary embodiment of the technique in accordance with the present invention is shown in FIG. 3. For example, a depth or lateral profile 1 can be acquired with wave front deformation pattern 1 3000, followed by acquisition of profile 2 acquired with wave front deformation pattern 2 3010. The information in depth profiles 1 and 2 can then be averaged to reduce speckle 3020. The amount of speckle reduction can be improved by acquiring and averaging together the information from a greater number of depth profiles corresponding to a greater number of wave front deformation patterns.

In order not to change the axial resolution of the system, it is preferred that the overall beam path length varies by less than the axial resolution of the system from one pattern to the next. Additionally, the lateral resolution of the system can be largely preserved by insuring that there is minimal angular displacement of and minimal degradation in the focusing of the sample beam caused by the wave front altering optical element.

Certain exemplary realizations of the exemplary embodiments of the present invention in a reflection geometry can include, but are not limited to, the use of a micro-deformable mirror (mDM), using a reflective membrane on which a surface wave is introduced, and using a spinning, translating, or rotating reflective element where different wave front patterns are introduced by moving different areas of the optical element into the sample beam path for successive measurement. Other exemplary realizations in a transmission geometry can include, but are not limited to, the use of a solid or gaseous transmissive element through which vibrations or acoustic waves can be sent, using a liquid crystal device to alter the phases of beamlets passing through it, or spinning, translating, or rotating a transmissive optical element where different beamlet path length patterns can be introduced by moving different parts of the optical element into the sample beam path. In various cases, it is only preferable to be able to introduce small relative path length or phase variations between beamlets of the overall sample optical beam such that wave front of the beam is modified, and to be able to vary the pattern of this wave front alteration between successive measurements.

One of the exemplary objects of the present invention is to reduce speckle by averaging small numbers of measurements with different speckle patterns together. By rapidly varying the speckle pattern between acquisition of successive depth scans of an OCT image, a significant speckle reduction can be achieved within a single image. In addition to conventional intensity OCT imaging, the exemplary embodiments of the present invention can be used with extensions or variants of OCT, including, but not limited to the polarization-sensitive OCT and Doppler OCT systems and processes. Since an exemplary application of wave front alteration likely should change the speckle pattern, without the changes to the basic structure of the image, these functional extensions and variants of OCT should not be significantly adversely affected by the exemplary embodiments of the technique(s) in accordance with the present invention. One of the effects of the exemplary embodiments of the present invention on these extensions and variants can be an increase in the minimal detectable phase difference that is resolvable.

The exemplary embodiments of the present invention can also be used in conjunction with an adaptive optics system. Adaptive optics systems generally use a wave front sensor and a wave front altering element to flatten the wave front in the sample beam path in order to improve the lateral resolution of resulting images. The type of wave front modifications preferable for the exemplary embodiments of the present invention can be superimposed on that required for adaptive optics to reduce the appearance of speckle within the resulting images as well.

Another use of the exemplary embodiments of the present invention may be to modify the focus of the beam incident on the sample to detect sub-structures within the focal volume of the sample. The incident beam focus can be modulated to match small substructures within the focal volume of the sample. For example, the spatial structure of the focus can be designed to give maximum reflection for substructures of a particular spacing and size. A comparison of such a measurement with other measurements with different modulated focal patterns can then yield information on structures smaller than the focal volume in size.

Exemplary Supporting Data

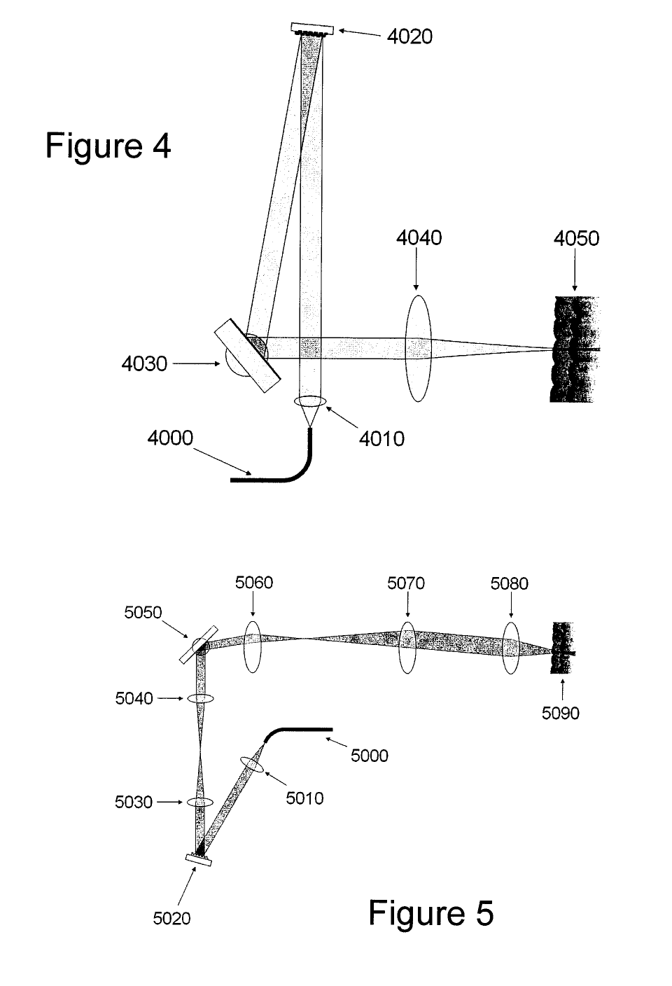

An exemplary implementation of the exemplary embodiment of the present invention using a micro-deformable mirror mDM 4020 is shown in FIG. 4. For example, the mDM 4020 has a 3×3 mm square reflective surface which can be modified by 140 actuators in a 12×12 array (the corners of the array are not controllable). The sample arm of a spectral-domain OCT system can be composed of a collimator 4010 that directs a 2 mm diameter beam to the micro-deformable mirror 4020. The light can be reflected on to a galvanometer-mounted mirror 4030, which scans the light on the sample 4050 after it is passed through a focusing lens 4040 (f=60 mm).

FIG. 5 is an illustration of an exemplary implementation of a use of the system and process in accordance with an exemplary embodiment of the present invention, which uses additional lenses in a telecentric configuration. For example, the exemplary configuration includes lenses 5010 and 5080 and a collimator 5050 which are similar to the lenses 4010 and 4040 and the collimator 4030, respectively, of FIG. 4. In addition, the exemplary configuration of FIG. 5 utilizes a mirror 5020 to direct the beams to the additional lenses 5030 and 5040, which direct the beams to the collimator 5050. The collimator 5040 then directs the beams to the further lenses 5060, 5070, which forward the beams to the sample 5090 through the lens 5080. Such a configuration allows light at the micro-deformable mirror mDM 5020 and the galvanometer-mounted mirror 5050 to be in conjugate planes of the back aperture of the final focusing lens 5080.

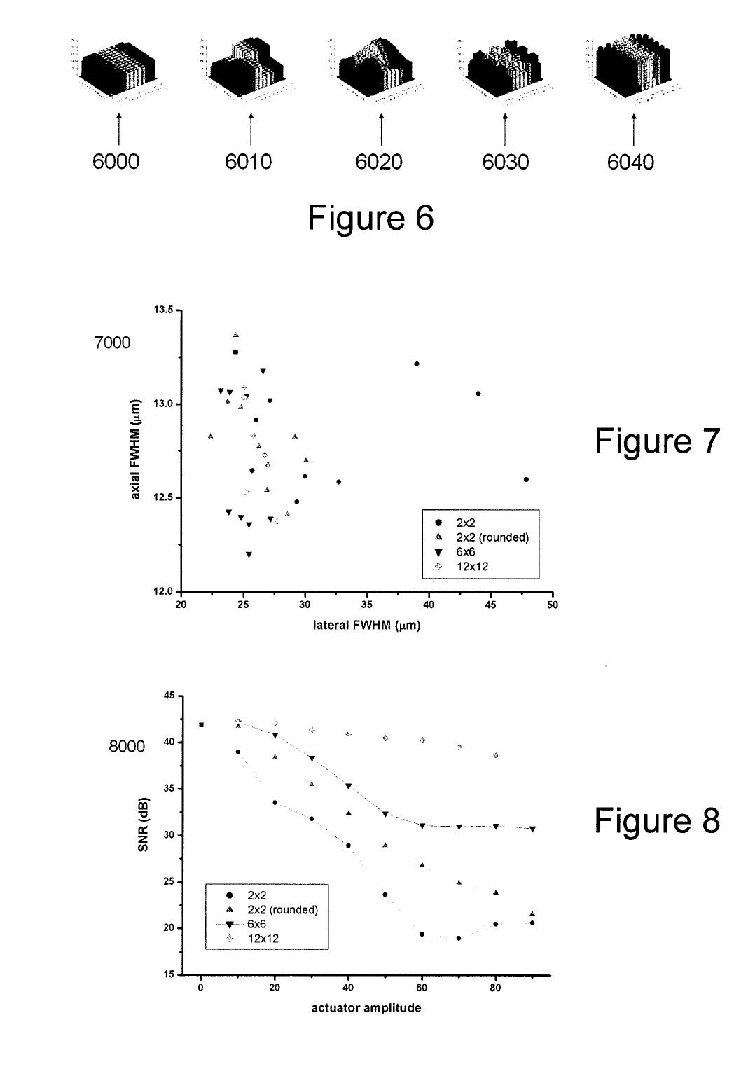

The actuators of the mDM may be set according to certain exemplary patterns with various spatial frequencies and amplitudes such that the overall height of the patterns was constant. The mirror patterns used in this exemplary embodiment can be denoted by 2×2 6000, 2×2s 6010, 6×6 6020, and 12×12 6030, as illustrated in FIG. 6. The patterns may be based on checkerboards, where each piece was composed of a number of actuators. For example, for the 12×12 pattern 6030, the height of each actuator alternated between two values centered around the middle height of the actuator. For the 2×2 pattern 6000, the height of squares composed of 36 actuators alternated between values can be calculated in the same manner. The 2×2s pattern 6010 is a sinusoidally-smoothed version of the 2×2 pattern 6000.

The coupling efficiency, lateral and axial resolution of the system in accordance with the exemplary embodiment of the present invention can be determined by imaging a resolution target (e.g., Air Force 1951) for stationary patterns with varying amplitudes. The results of these exemplary measurements 7000 and 8000, respectively, are shown in FIGS. 7 and 8. For example, the axial FWHM for the different patterns varied from 12.2 to 13.4 microns, which represents an exemplary minimal variation in axial resolution. For various exemplary patterns, the lateral resolution did not change significantly either, ranging from 22 to 31 microns. In certain cases, the lateral resolution degraded, but this degradation can be attributed to reflected angular deviations for the 2×2 pattern. The efficiency of the overall sample imaging system demonstrated a decreasing signal-to-noise ratio (SNR) of the reflected signal for increasing amplitudes of the various patterns. Mirror pattern pairs were chosen based on their SNR values.

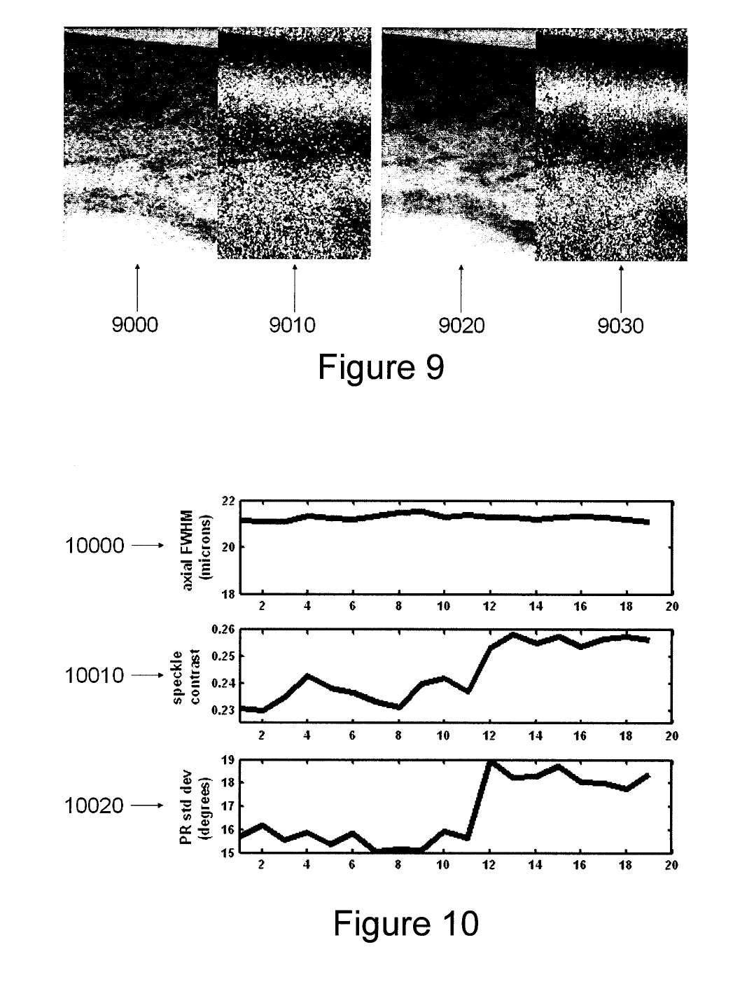

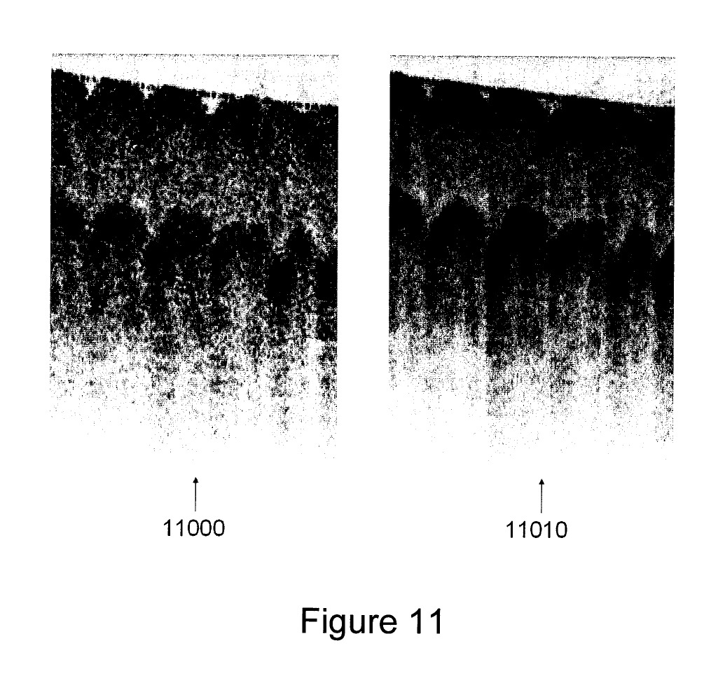

A sequence of images of an exemplary sample of chicken muscle were acquired using the exemplary embodiment of the system and process according to the present invention while alternating the mDM between a 6×6 pattern and a matching 12×12 pattern at approximately the same rate as the depth scan acquisition rate. The same exemplary sample was then imaged using the stationary 6×6 pattern. The images were composed of 2048×256 pixels covering an area 2×2 mm, and were processed identically by averaging 4 depth scans together. Representative images are shown in FIG. 9. The appearance of speckle is visibly reduced for the intensity and polarization images acquired while alternating between mirror patterns 9010, while the overall intensity and phase retardation images remained the same. The exemplary axial resolution as determined from the highly reflective surface of the sample 10000, the exemplary ratio between the standard deviation and mean of the intensity (e.g., speckle contrast ratio) 10010, and the standard deviation of the phase retardation 10020 were determined during the imaging sequence, and shown in FIG. 10. The state of the mirror changed from being alternated to stationary between frames 11 and 12. This is indicated by a sharp increase in both the speckle contrast ratio and standard deviation of the calculated phase retardation. There was no significant change in the axial resolution. The data demonstrates that speckle is reduced by alternating the mirror pattern between two states with no loss in resolution.

Substantially the same region of a human fingertip was imaged using both a stationary mirror pattern 11000 and alternating between mirror patterns between successive depth scans 11010. The appearance of speckle is illustrated in the images shown in FIG. 1. References described herein are as follows
1. Huang, D., Swanson, E. A., Lin, C. P., Schuman, J. S., Stinson, W. G., Chang, W., Hee, M. R., Flotte, T., Gregory, K., Puliafito, C. A., and Fujimoto, J. G., Optical Coherence Tomography. Science, 1991. 254(5035): p. 1178-1181.
2. de Boer, J. F., Milner, T. E., van Gemert, M. J. C., and Nelson, J. S., Two-dimensional birefringence imaging in biological tissue by polarization-sensitive optical coherence tomography. Opt. Lett., 1997. 22(12): p. 934-936.
3. Everett, M. J., Schoenenberger, K., Colston, B. W., and Da Silva, L. B., Birefringence characterization of biological tissue by use of optical coherence tomography. Opt. Lett., 1998. 23(3): p. 228-230.
4. de Boer, J. F., Srinivas, S. M., Malekafzali, A., Chen, Z., and Nelson, J. S., Imaging thermally damaged tissue by polarization sensitive optical coherence tomography. Opt. Exp., 1998. 3(6): p. 212-218.
5. Schmitt, J. M. and Xiang, S. H., Cross-polarized backscatter in optical coherence tomography of biological tissue. Opt. Lett., 1998. 23(13): p. 1060-1062.
6. de Boer, J. F., Milner, T. E., and Nelson, J. S., Determination of the depth-resolved Stokes parameters of light backscattered from turbid media by use of polarization-sensitive optical coherence tomography. Optics Letters, 1999. 24(5): p. 300-302.
7. Chen, Z. P., Milner, T. E., Srinivas, S., Wang, X. J., Malekafzali, A., vanGemert, M. J. C., and Nelson, J. S., Noninvasive imaging of in vivo blood flow velocity using optical Doppler tomography. Optics Letters, 1997. 22(14): p. 1119-1121.
8. Izatt, J. A., Kulkami, M. D., Yazdanfar, S., Barton, J. K., and Welch, A. J., In vivo bidirectional color Dopplerflow imaging of picoliter blood volumes using optical coherence tomograghy. Optics Letters, 1997. 22(18): p. 1439-1441.
9. Zhao, Y. H., Chen, Z. P., Saxer, C., Xiang, S. H., de Boer, J. F., and Nelson, J. S., Phase-resolved optical coherence tomography and optical Doppler tomography for imaging blood flow in human skin with fast scanning speed and high velocity sensitivity. Optics Letters, 2000. 25(2): p. 114-116.
10. Zhao, Y. H., Chen, Z. P., Saxer, C., Shen, Q. M., Xiang, S. H., de Boer, J. F., and Nelson, J. S., Doppler standard deviation imaging for clinical monitoring of in vivo human skin blood flow. Optics Letters, 2000. 25(18): p. 1358-1360.
11. Schmitt, J. M., Xiang, S. H., and Yung, K. M., Speckle in optical coherence tomography. Journal of Biomedical Optics, 1999. 4(1): p. 95-105.
12. Wax, A. and Thomas, J. E., Measurement of smoothed Wigner phase-space distributions for small-angle scattering in a turbid medium. Journal of the Optical Society of America a—Optics Image Science and Vision, 1998. 15(7): p. 1896-1908.
13. Dainty, J. C., Laser Speckle and Related Phenomena. 1984: Springer-Verlag.

The foregoing merely illustrates the principles of the invention. Various modifications and alterations to the described embodiments will be apparent to those skilled in the art in view of the teachings herein. Indeed, the arrangements, systems and methods according to the exemplary embodiments of the present invention can be used with and/or implement any OCT system, OFDI system, SD-OCT system or other imaging systems, and for example with those described in International Patent Application PCT/US2004/029148, filed Sep. 8, 2004, U.S. patent application Ser. No. 11/266,779, filed Nov. 2, 2005, and U.S. patent application Ser. No. 10/501,276, filed Jul. 9, 2004, the disclosures of which are incorporated by reference herein in their entireties. It will thus be appreciated that those skilled in the art will be able to devise numerous systems, arrangements and methods which, although not explicitly shown or described herein, embody the principles of the invention and are thus within the spirit and scope of the present invention. In addition, to the extent that the prior art knowledge has not been explicitly incorporated by reference herein above, it is explicitly being incorporated herein in its entirety. All publications referenced herein above are incorporated herein by reference in their entireties.

What is claimed is:

1. A system for generating information associated with at least one portion of a sample, comprising:
at least one first arrangement which is configured to:
i) at least one of receive from the at least one portion or transmit to at least one electromagnetic radiation to the at least one portion,
ii) provide at least one first wave front of the at least one electromagnetic radiation at least one of received from or transmitted to the at least one portion to generate at least one first transmitted wave front,
iii) after the first transmitted wave front is generated, modify at least one characteristic of at least one second wave front of the at least one electro-magnetic radiation at least one of received from or transmitted to the at least one portion to generate at least one second modified wave front which is different from the first transmitted wave front; and
at least one second arrangement which is configured to generate the information based on the first transmitted wave front and the second modified wave front.

2. The system according to claim 1, wherein the at least one first arrangement modifies at least one characteristic of the at least one first wave front to generate a first modified wave front prior to the modification of the at least one characteristic of the at least one second wave front.

3. The system according to claim 2, wherein the at least one second arrangement generates the information based on the first and second modified wave fronts.

4. The system according to claim 2, wherein the at least one second arrangement generates further information based on the first and second modified wave fronts, the further information being associated with a particular volume of the at least one portion which is smaller than a focal volume of the at least one portion that receives the at least one electromagnetic radiation.

5. The system according to claim 1, wherein the at least one first arrangement comprises at least one of a micro-deformable mirror, a deformable reflective membrane, a deformable transmissive membrane, an electro-optical spatial light modulation arrangement, a rotating or translating, reflective or transmissive element, or an apparatus which is configure to modify a wave front of the at least one electromagnetic radiation.

6. The system according to claim 1, wherein the at least one second arrangement is configured to average the information to produce resultant data in which a speckle noise is lower than the speckle noise in the information.

7. The system according to claim 1, wherein the at least one first arrangement are situated in a catheter arrangement.

8. The system according to claim 1, wherein the at least one second arrangement comprises an interferometric arrangement which receives at least the first and second wave fronts from a sample arm and a further electromagnetic radiation from a reference arm.

9. The system according to claim 1, wherein the first and second wave fronts are associated with approximately the same focal volume within the at least one portion of the sample.

10. The system according to claim 1, wherein the at least one second arrangement comprises a confocal microscope arrangement.

11. The system according to claim 1, wherein the at least one characteristic of the at least one second wave front of the at least one electromagnetic radiation is a phase of the at least one second wave front, and wherein the at least one first arrangement modifies the phase by at most approximately 2π.

12. The system according to claim 1, wherein the at least one first arrangement is further configured to compensate for a predetermined wave front distortion associated with at least one of the at least one portion of the sample or an optical beam path within at least one of the first arrangement or the second arrangement.

13. The system according to claim 1, wherein the at least one first arrangement further comprises at least one third arrangement which is at least one of at least one optical fiber or a structure having a pinhole, and wherein the at least one third arrangement is configured to select at least one portion of the at least one electro-magnetic radiation received from the at least one portion of the sample.

14. The system according to claim 1, wherein the information is associated with at least one of a reflectivity of, a motion within or a polarization property of the at least one portion.

15. The system according to claim 1, further comprising a further arrangement which is configured to scan the at least one portion using the at least one electromagnetic radiation over the at least one portion to generate further information which is associated with at least one of a two-dimension image or a three-dimensional image of the at least one portion.

16. The system according to claim 1, wherein the sample includes an anatomical structure.

17. A method for generating information associated with at least one portion of a sample, comprising:
a) receiving from the at least one portion or transmitting to at least one electromagnetic radiation to the at least one portion,
b) providing at least one first wave front of the at least one electromagnetic radiation at least one of received from or transmitted to the at least one portion to generate at least one first transmitted wave front,
c) after the first transmitted wave front is generated, modifying at least one characteristic of at least one second wave front of the at least one electromagnetic radiation at least one of received from or transmitted to the at least one portion to generate at least one second modified wave front which is different from the first transmitted wave front; and
d) generating the information based on the first transmitted wave front and the second modified wave front.

18. The method according to claim 17, further comprising:
e) modifying at least one characteristic of the at least one first wave front to generate a first modified wave front prior to the modification of the at least one characteristic of the at least one second wave front, wherein the information is generated based on the first and second modified wave fronts.

19. The method according to claim 17, further comprising:
f) averaging the information to produce resultant data in which a speckle noise is lower than the speckle noise in the information.

20. The method according to claim 17, further comprising:
g) compensating for a predetermined wave front distortion associated with at least one of the at least one portion of the sample or an optical beam path within at least one arrangement configured to perform at least one of steps (a)-(d).

21. The method according to claim 17, further comprising:
h) generating further information based on the first and second modified wave fronts, the further information being associated with a particular volume of the at least one portion which is smaller than a focal volume of the at least one portion that receives the at least one electromagnetic radiation.
